(19) United States
(12) Patent Application Publication
(10) Pub. No.: US 2006/0090030 A1
(43) Pub. Date: Apr. 27, 2006

(54) Device and method for storing information

(75) Inventors: Pieter-Bas Ijdens, Eindhoven (NL); Wilhelmus Fransiscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronic N.V., Eindhoven (NL)

(21) Appl. No.: 10/514,289

(22) PCT Filed: Apr. 22, 2003
(86) PCT No.: PCT/IB03/01545

§ 371 Date: Nov. 12, 2004

(30) Foreign Application Priority Data
May 17, 2002 (EP) 020769469

(51) Int. Cl. G06F 13/00

(52) U.S. Cl. 711/111

(57) ABSTRACT

A storage device for recording and retrieving information blocks on a removable record carrier is described. Via an interface (44) the device receives commands, user data blocks and meta data blocks comprising file management information. The device has a non-volatile memory (31), a meta data block detection unit (47), and a control unit (20). The device temporarily stores the meta data blocks in the non-volatile memory until detecting an update condition, e.g. an eject command. The update condition indicates that the removable record carrier is to be updated to a state in which the record carrier is usable in a different storage device. In the event that the update condition has been detected the meta data blocks are transferred from the non-volatile memory to the record carrier (49).

The invention relates to a storage device for recording and retrieving information blocks.

The invention further relates to a method of storing information blocks.

The invention further relates to a computer program product for storing information blocks.

A device and method for storing information on a record carrier is known from U.S. Pat. No. 6,219,693. File-away storage architecture is described, which comprises a file system that is distributed across a data processing platform consisting of a host computer coupled to an adapter over a data interface. On the adapter there is located an input/output subsystem and a non-volatile memory. The adapter is coupled via a second data interface to at least one storage device of a standard type, e.g. a hard disk. The subsystem performs independently tasks of a local file management system. The distributed nature of the architecture enables implementation of the file system in accordance with a client-server computing model. The server file system is executing on the adapter, and deciding to store metadata in the non-volatile memory. For the host computer a high-speed storage system is provided due to the functions performed on the adapter. However, the adapter and the independent server file system are complex. Further the adapter is arranged to be coupled to a storage device of a standard type, primarily a hard disk type, and the control of the storage of meta data in the non-volatile memory is to be based on the functions of the server file system in combination with such a standard type device only. A problem is that the performance of the server file system is not optimal for specific types of storage devices

It is an object of the invention to provide a system for storing information which is less complex and solves the above problems.

For this purpose, the storage device as described in the opening paragraph is for recording and retrieving information blocks in a recordable area on a removable record carrier, and comprises data interface means for receiving commands, in particular writing and reading commands, and for transferring the information blocks, in particular user data blocks and meta data blocks comprising file management information formatted according to a file management system, a non-volatile memory, meta data block detection means for detecting information blocks comprising meta data, and control means for controlling the recording and retrieving of the information blocks, which control means comprise means for storing the meta data blocks in the non-volatile memory, and for detecting an update condition, which update condition relates to updating the removable record carrier to an updated state in which the record carrier is usable in a different storage device, and for, in the event that the update condition has been detected, transferring the meta data blocks from the non-volatile memory to the record carrier. The method as described in the opening paragraph is for recording and retrieving information blocks in a recordable area on a removable record carrier, and comprises receiving commands on a data interface, in particular writing and reading commands, and transferring the information blocks via the data interface, in particular user data blocks and meta data blocks comprising file management information formatted according to a file management system, meta data block detecting by detecting information blocks comprising meta data, controlling recording and retrieving of the information blocks, which controlling comprises storing the meta data blocks in a non-volatile memory, detecting an update condition, which update condition relates to updating the removable record carrier to an updated state in which the record carrier is usable in a different storage device, and, in the event that the update condition has been detected, transferring the meta data blocks from the non-volatile memory to the record carrier. The measures have the advantage that the non-volatile memory is effectively used as a meta data storage during the time the removable record carrier is mounted in the device. This increases the speed of accessing data on the record carrier, because there is less writing and/or reading on the record carrier for accessing the meta data, which is called seek overhead limitation. In particular the speed at a remount, i.e. restarting the device after a reboot of a host system without ejecting the record carrier, is increased, because the relevant meta data is still in the non-volatile memory. The same holds after a power failure or a ‘hang-up’ of a host system. In addition this is advantageous for limiting the amount of wear on locations of the record carrier containing meta data which is often changed. This is particularly relevant for optical discs of the phase change type, which can deal only with a limited number of overwrites per location due to wear of rewriting. Another advantage is that the power consumption is reduced. This is very useful in case of portable devices. Further it is to be noted that the updating step is automatically added before the record carrier is removed from the device. Also, as long as the same record carrier remains in the device, the start-up time of the device, called mount time, is shortened, because (part of) the meta data is already available in the non-volatile memory. Hence the device has the increased performance for the removable type of record carrier without requiring any user intervention.

The invention is based on the following recognition. First the inventors have seen that having a non-volatile memory for permanent storage of meta data does have advantages, but is also relatively expensive. This also holds for removable type record carriers having a non-volatile memory build in the medium or its cartridge, which requires expensive additional interfacing. Hence for mass storage and consumer applications such non-volatile memory solutions are not viable. Otherwise a standard cache solution or a dedicated meta data cache solution as described in U.S. Pat. No. 6,219,693 are not suitable for removable (optical) media. There is described an adapter running a server file system, which does not allow interfacing to a standard host system running a standard file system configuration. Such architectures lack generic file system compatibility. Also the storage device interface of the adapter is not optimized for storage devices having removable record carriers. In particular there is no way of detecting the eject command given to the storage device, and hence the update condition cannot be detected. The inventors have seen that a solution resides in having the non-volatile memory inside the storage device and detecting the meta data and the update condition within the storage device. This allows interfacing to substantially standard file management or operating system software on slow or low-cyclability media.

In an embodiment of the device the meta data block detection means are for detecting a meta data block by the formatting as applied by the file management system. This has the advantage that the storage device is operating independently of the file management system in the host computer. Hence this file management system does not require any specific settings or does not need to issue specific commands. For the user this results in a real plug-and-play situation.

In an embodiment of the device the meta data block detection means are for detecting a meta data block by detecting, from addressing information received on the data interface means, that an information block is to be stored in a dedicated file management area on the record carrier. This has the advantage, that the device is arranged for efficiently recording the meta data in the file management area, e.g. by reading, writing and/or updating the file management area consecutively.

It is noted that a paper appeared in the 8th IEEE Workshop on Hot Topics in Operating Systems (HOTOS-VIII), Schloss Elmau, Germany, May 2001. The paper, called HeRMES: High-Performance Reliable MRAM-Enabled Storage, by Ethan L. Miller, Scott A. Brandt and Darrell D. E. Long, describes devices having a non-volatile memory of the MRAM type for storing meta data permanently. Further a specific file management system is described using the advantage of having the file management data only in the non-volatile random access memory. However devices for removable record carriers interfacing via a standard interface for storing data according to a standard file system are not discussed.

These and other aspects of the invention will be apparent from and elucidated further with reference to the embodiments described by way of example in the following description and with reference to the accompanying drawings, in which

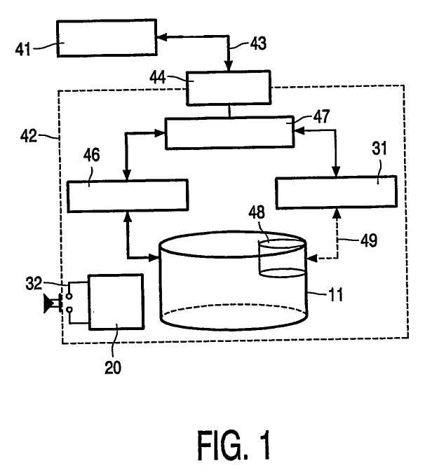

FIG. 1 shows a storage device for a removable record carrier,

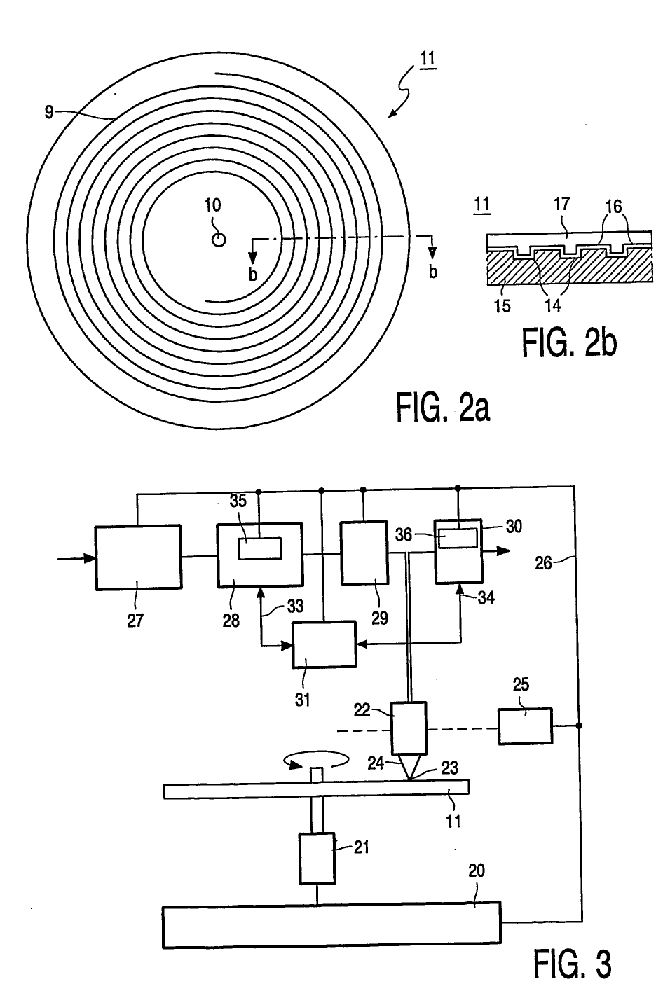

FIG. 2a shows a record carrier (top view),

FIG. 2b shows a record carrier (cross section), and

FIG. 3 shows a recording device for an optical record carrier.

Corresponding elements in different Figures have identical reference numerals.

FIG. 1 shows a storage device for a removable record carrier. A storage device 42 for recording and retrieving information blocks is indicated by the dashed line, coupled via a data interface 43 to a user data processing device 41, e.g. a host computer. A record carrier 11 is schematically indicated within the device 42, and is removable and replaceable by a different record carrier, e.g. exchangeable hard disk cartridges or optical discs. The information blocks are to be stored in a recordable area on the record carrier. The device has a data interface unit 44 for receiving commands, in particular writing and reading commands, and for transferring the information blocks, to the host computer 41. The information blocks comprise user data blocks and meta data blocks. Meta data blocks contain file management information formatted according to a file management system (FS), usually a standard file system like UDF (see e.g. Universal Disk Format Specification Revision 2.01 available from www.osta.org). The device has a meta data detection unit 47 coupled to the data interface unit 44 for screening information blocks and a read/write unit 46 coupled to the meta data detection unit 47 for processing user data blocks. Further the device has a non-volatile memory 31 coupled to the meta data detection unit 47 for processing meta data blocks. Information blocks which enter the device to be recorded on the record carrier are first received in the meta data detection unit 47, which determines the type of the information block. The detection is described below in detail. Information blocks of the meta data type are transferred to the non-volatile memory 31, and stored there. User data blocks are coupled to a general write/read unit 46. The general write/read unit is arranged for writing and/or reading the user data blocks on/from the record carrier 11. In an embodiment of the device the general write/read unit 46 further has a general cache memory for temporarily storing user data blocks in a customary way. The device has a control unit 20, for example a microprocessor unit, for controlling the recording and retrieving of the information blocks in cooperation with the meta data detection unit 47. The control unit is also arranged for detecting an update condition. The update condition relates to updating the removable record carrier to an updated state in which the record carrier is usable in a different storage device, in particular after removing the record carrier from the device. In the event that the update condition has been detected, the control unit will perform an updating procedure 49. During said updating 49 the contents of the non volatile memory 31 are transferred to the record carrier 11.

In an embodiment of the device the meta data block detection unit 47 is arranged for detecting a meta data block by the formatting as applied by the file management system. The file management system usually adds specific parameters to the information blocks, e.g. specific information added to the header of an information block as defined in the UDF file system. The meta data block detection unit 47 detects the specific values in the headers and determines if the information block contains meta data.). In addition in a recording system there may be defined specific types of data to be handled and stored, including meta data blocks not formatted as standard file system data blocks. It is noted that such specific meta data is also included in the concept of meta data blocks as referred to in this document. For example the proposed CD2 disc format includes a special area on disc that contains digital right management data (DRM, rights and keys), which is protected by a hidden channel. This data needs to be cached by the drive as required in the specific proposed data recording system. In the CD2 system encryption takes place at sector level not the file level. On the other hand rights and keys are defined at file level or higher. The CD2 DRM data is neither part of a UDF structure nor referenced by UDF structures, but an example of an other kind of meta data not being file system meta data. In an embodiment the DRM meta data can be written to the non-volatile memory cache without any block formatting applied. Some of the rights proposed at the moment for the CD2 system even depend on this cache (e.g. play disc×n times per player). The standard enables consumable and updatable rights. The current DRM state needs to be up-to-date on the disc. However, if a Recordable disc (write once) is used and the current DRM state is written to the disc at each instance the state changes, a lot of space on the medium is wasted. If rights are cached in the drive and only written at eject time a lot of space is saved without loosing any functionality. So caching of keys and rights parameters solved part of the problem. There is one drawback to this solution and that is that if the drive looses power before the rights are stored on disc (e.g. cold reboot) the information is lost and so might the disc. This is a severe problem as the consumers have paid for their rights and they will not appreciate if they loose money this way. One solution to this problem would be to cache the rights on another medium, i.e. the hard disk, but this has negative security implications. A solution to this drawback is to apply NVRAM in the drive. So the drive can complete any pending disc updates even after a power down.

In an embodiment of the device the meta data block detection means are arranged for detecting a meta data block based on addressing information received on the data interface means. The record carrier for this embodiment has a specific file management area 48 for storing the meta data. By detecting an address within the range of addresses of the file management area 48 it is determined that an information block is to be stored in the dedicated file management area on the record carrier. The detected meta data block is stored in the non-volatile memory 31 until the update condition is detected. For example most UDF implementations currently use a specific portion of the disc for recording file system data. Recognizing and caching this area would dramatically improve the performance of a UDF disc in this special drive.

In an embodiment of the device the meta data block detection means are arranged for detecting a meta data block by monitoring the command given by the file management system. There may for example be added a specific command or parameter or tag to a writing command for writing meta data. Alternatively the file management system may be adapted to add such parameters to the write commands.

In an embodiment of the device the control unit is arranged for detecting an update condition based on detecting an eject command or update command from the data interface. For example the user may give a command on the host computer for ejecting the record carrier from the storage device. The host computer will then translate the user command and transfer the command via the data interface 43.

In an embodiment of the device the device comprises a user operable switch for removing the record carrier from the device, for example an eject button. The control unit is arranged for detecting the update condition by detecting operating said switch.

In the embodiments above the writing of meta data blocks has been described. Of course a corresponding approach may be used for read commands. The meta data detection unit 47 may be similarly arranged for detecting meta data blocks in the information blocks retrieved from the record carrier or from the read command. The meta data blocks are subsequently stored in the non-volatile memory 31. For meta data read commands the contents of the non-volatile memory are examined first to prevent accessing the record carrier unnecessarily. In an embodiment of the device the control unit is arranged for transferring meta data blocks from the record carrier to the non-volatile memory 31 independently, i.e. without a read command, after a record carrier has been inserted in the device. For example the device is arranged to recognize the type of file management system used on the disc, and start reading the meta data from the file management area, e.g. as a background process for filling the non-volatile memory with existing meta data.

FIG. 2a shows a disc-shaped record carrier 11 having a track 9 and a central hole 10. The track 9, being the position of the series of (to be) recorded marks representing information, is arranged in accordance with a spiral pattern of turns constituting substantially parallel tracks on an information layer. The record carrier may be optically readable, called an optical disc, and has an information layer of a recordable type. Examples of a recordable disc are the CD-R and CD-RW, and writable versions of DVD, such as DVD+RW, and the high density writable optical disc using blue lasers, called Blue-ray Disc (BD). Further details about the DVD disc can be found in reference: ECMA-267: 120 mm DVD—Read-Only Disc—(1997). The information is represented on the information layer by recording optically detectable marks along the track, e.g. crystalline or amorphous marks in phase change material. The track 9 on the recordable type of record carrier is indicated by a pre-embossed track structure provided during manufacture of the blank record carrier. The track structure is constituted, for example, by a pregroove 14 which enables a read/write head to follow the track during scanning. The track structure comprises position information, e.g. addresses, for indication the location of units of information, usually called information blocks. The position information includes specific synchronizing marks for locating the start of such information blocks. The position information is encoded in frames of modulated wobbles as described below.

FIG. 2b is a cross-section taken along the line b-b of the record carrier 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

The record carrier 11 is intended for carrying information in information blocks according to a standardized file management system.

FIG. 3 shows a recording device for writing information on a record carrier 11 of a type which is writable or re-writable, for example CD-R or CD-RW, or DVD+RW or BD. The device is provided with recording means for scanning the track on the record carrier which means include a drive unit 21 for rotating the record carrier 11, a head 22, a positioning unit 25 for coarsely positioning the head 22 in the radial direction on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. For writing information the radiation is controlled to create optically detectable marks in the recording layer. For reading the radiation reflected by the information layer is detected by a detector of a usual type, e.g. a four-quadrant diode, in the head 22 for generating a read signal and further detector signals including a tracking error and a focusing error signal for controlling said tracking and focusing actuators. The read signal is processed by read processing unit 30 of a usual type including a demodulator, deformatter and output unit to retrieve the information. Hence retrieving means for reading information include the drive unit 21, the head 22, the positioning unit 25 and the read processing unit 30. The device comprises write processing means for processing the input information to generate a write signal to drive the head 22, which means may comprise an input unit 27, and modulator means comprising a formatter 28 and a modulator 29. User video information is presented on the input unit 27, which may comprise of compression means for input signals such as analog audio and/or video, or digital uncompressed audio/video. Suitable compression means are described for audio in WO 98/16014-A1 (PHN 16312), and for video in the MPEG2 standard. The input signal may alternatively be already encoded. MPEG is a video signal compression standard, established by the Moving Picture Experts Group (“MPEG”) of the International Standardization Organization (ISO). MPEG is a multistage algorithm that integrates a number of well known data compression techniques into a single system. MPEG-1 is defined in ISO/IEC 11172 and MPEG-2 is defined in ISO/IEC 13818. It is noted that for computer applications a host computer may be interfaced to the formatter 28 directly. Hence a data interface may either be internal in the device (e.g. a consumer video recorder) or externally available (e.g. a PC peripheral).

The control unit 20 controls the recording and retrieving of information and may be arranged for receiving commands from a user or from a host computer. The control unit 20 is connected via control lines 26, e.g. a system bus, to said input unit 27, formatter 28 and modulator 29, to the read processing unit 30, and to the drive unit 21, and the positioning unit 25. The control unit 20 comprises control circuitry, for example a microprocessor, a program memory and control gates, for performing the procedures and functions according to the invention as described below. The control unit 20 may also be implemented as a state machine in logic circuits. The input unit 27 processes the audio and/or video to unit of information, which are passed to the formatter 28 for adding control data and formatting the data according to a file management system. The formatted data from the output of the formatter 28 is passed to the modulation unit 29, which comprises for example a channel coder, for generating a modulated signal which drives the head 22. Further the modulation unit 29 comprises synchronizing means for including synchronizing patterns in the modulated signal. The formatted units presented to the input of the modulation unit 29 comprise address information and are written to corresponding addressable locations on the record carrier under the control of control unit 20. The control unit 20 is arranged for recording and retrieving position data indicative of the position of the recorded information volumes. During the writing operation, marks representing the information are formed on the record carrier. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material. Writing and reading of information for recording on optical disks and usable formatting, error correcting and channel coding rules are well-known in the art, e.g. from the CD system. The marks can be formed by means of the spot 23 generated on the recording layer via the beam 24 of electromagnetic radiation, usually from a laser diode. The device has a non-volatile memory 31 coupled to the formatter 28 via an interface 33. The non-volatile memory 31 may also be coupled to the read processing unit 30 via an interface 34. The formatter 28 is provided with a meta data detection unit 35 for detecting information blocks that contain meta data for controlling the access to the user data. The meta data may be formatted according to a standardized file management system, but may alternatively be meta data for accessing audio or video data, for example in a DVD video recorder. Control unit 20 is arranged for storing the meta data blocks, when detected, in the non-volatile memory 31. Further the control unit 20 is arranged for detecting an update condition as described with reference to FIG. 1. The control unit 20 is arranged for executing the update procedure by recording the meta data blocks in the non-volatile memory 31 on the record carrier. In an embodiment the read processing unit 30 is provided with a read meta data detection unit 36 for detecting meta data blocks read from the record carrier. The detected meta data blocks are stored in the non-volatile memory 31 for future use. In the non-volatile memory there may also be stored an indicator for each block indicating its update status, i.e. the need to write the block to the record carrier at the update procedure. The status will be ‘no update needed’ for meta data blocks only read from the record carrier.

In an embodiment of the device the control unit and the functions of meta data detection and control of the non volatile memory are implemented in a software program. The software program running in suitable processor is controlling the execution of the recording process in a disc drive unit, e.g. an optical disc recorder coupled via an interface bus or network to a PC. The software program may be a separate driver type software package running in a host computer for performing (part of) the control functions, or it may be a executable file to be entered in the storage device itself, e.g. in the form of an update of the software already present a program memory (e.g. EPROM flash memory) in the storage device.

Although the invention has been explained mainly by embodiments using the optical disc, similar embodiments like a storage device using magnetic tape are also suitable. Also for the information carrier an optical disc has been described, but other media, such as a magnetic disc or tape, may be used. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ may be represented by the same item of hardware. Further, the scope of the invention is not limited to the embodiments, and the invention lies in each and every novel feature or combination of features described above.

1. Storage device for recording and retrieving information blocks in a recordable area on a removable record carrier, which device comprises
data interface means for receiving commands, in particular writing and reading commands, and for transferring the information blocks, in particular user data blocks and meta data blocks comprising file management information formatted according to a file management system,
a non-volatile memory,
meta data block detection means for detecting information blocks comprising meta data, and
control means for controlling the recording and retrieving of the information blocks,
which control means comprise means
for storing the meta data blocks in the non-volatile memory, and
for detecting an update condition, which update condition relates to updating the removable record carrier to an updated state in which the record carrier is usable in a different storage device, and
for, in the event that the update condition has been detected, transferring the meta data blocks from the non-volatile memory to the record carrier.

2. Device as claimed in claim 1, wherein the meta data block detection means are for detecting a meta data block by the formatting as applied by the file management system.

3. Device as claimed in claim 1, wherein the meta data block detection means are for detecting a meta data block by detecting, from addressing information received on the data interface means, that an information block is to be stored in a dedicated file management area on the record carrier.

4. Device as claimed in claim 1, wherein the meta data block detection means are for detecting a meta data block by a predetermined command or parameter added to a writing command received by the data interface means.

5. Device as claimed in claim 1, wherein the means for detecting an update condition are for detecting an eject command or update command from the data interface.

6. Device as claimed in claim 1, wherein the device comprises a user operable switch for removing the record carrier from the device and the means for detecting an update condition are for detecting operating said switch.

7. Device as claimed in claim 1, wherein the device comprises an input unit for processing audio and/or video data coupled to the data interface means.

8. Method of storing information blocks in a recordable area on a removable record carrier, which method comprises
receiving commands on a data interface, in particular writing and reading commands, and
transferring the information blocks via the data interface, in particular user data blocks and meta data blocks comprising file management information formatted according to a file management system,
meta data block detecting by detecting information blocks comprising meta data, and
controlling recording and retrieving of the information blocks,
which controlling comprises
storing the meta data blocks in a non-volatile memory, and
detecting an update condition, which update condition relates to updating the removable record carrier to an updated state in which the record carrier is usable in a different storage device, and,
in the event that the update condition has been detected, transferring the meta data blocks from the non-volatile memory to the record carrier.

9. Computer program product for storing information, which program is operative to cause a processor to perform the method as claimed in claim 8.
